(19) United States
(12) Patent Application Publication
(10) Pub. No.: US 2007/0150661 A1
(43) Pub. Date: Jun. 28, 2007

(54) Information processing apparatus, information processing apparatus, and access control method

(75) Inventor: Yukihiro Suda, Tokorozawa-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/413,397

(22) Filed: Apr. 28, 2006

(30) Foreign Application Priority Data
Dec. 26, 2005 (JP) 2005-373351

(51) Int. Cl. G06F 12/00

(52) U.S. Cl. 711/137

(57) ABSTRACT

According to one embodiment, there is provided an information processing apparatus including a pattern acquiring unit configured to acquire an access pattern of a series of read access to a storage device when an operating system is booted, a data pre-read unit configured to pre-read read access target data from the storage device based on the access pattern and to load the data in a memory when the operating system is booted next, and an access unit configured to supply data requested by the read access to the operating system when the requested data exists in data loaded in the memory.

### CROSS-REFERENCE TO RELATED APPLICATIONS

This application is based upon and claims the benefit of priority from Japanese Patent Application No. 2005-373351, filed Dec. 26, 2005, the entire contents of which are incorporated herein by reference.

### BACKGROUND

1. Field

One embodiment of the invention relates to an information processing apparatus including an operating system, access control method and program.

2. Description of the Related Art

In an information processing apparatus such a personal computer (PC), when an operating system (OS) is booted after power-on, the OS performs a read access to a hard disk drive (HDD) via the file system and various drivers to acquire necessary data from the HDD. Various techniques have been proposed to shorten access time.

For example, the following technique is disclosed in Jpn. Pat. Appln. KOKAI Publication No. 2005-157711. According to the technique, in a storage device, an access history such as a data read is acquired for every computer, and then, stored in a cache controller. Based on the access history, data pre-read to a cache memory from a disk group is carried out.

According to the technique disclosed in the foregoing publication, the storage device is to be provided with new hardware (cache controller, cache memory) to realize data a pre-read. For this reason, the size and component mounting area of the storage device increase, and in addition, the manufacturing cost increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary front view showing a state that a display unit of a computer according to one embodiment of the present invention is opened;

FIG. 2 is an exemplary block diagram showing the system configuration of the computer;

FIG. 3 is an exemplary block diagram showing the configuration of various software intervening in a read access to an HDD when an OS included in the computer is booted;

FIG. 4 is an exemplary view to explain a procedure realized by a pattern acquiring function of a filter driver;

FIG. 5 is an exemplary view to explain a procedure realized by a data pre-read function of a filter driver;

FIG. 6 is an exemplary view to explain a procedure realized by an access function of a filter driver;

FIG. 7A and FIG. 7B are exemplary views to explain the confirmation of a pre-read pattern;

FIG. 8A and FIG. 8B are exemplary views to explain the effect of pre-read;

FIG. 9 is an exemplary view showing an example of using a non-volatile high-speed storage device in place of a pre-read buffer;

FIG. 10 is an exemplary view showing a modification example relevant to configuration of FIG. 3;

FIG. 11 is an exemplary view showing a first modification example relevant to a location of arranging a file system;

FIG. 12 is an exemplary view showing a second modification example relevant to a location of arranging an HDD driver;

FIG. 13 is an exemplary view showing a third modification example relevant to a location of arranging an IDE driver;

FIG. 14 is an exemplary flowchart to explain an access pattern acquiring procedure by a filter driver;

FIG. 15 is an exemplary flowchart to explain a pre-read procedure by a filter driver; and

FIG. 16 is an exemplary flowchart to explain a procedure with respect to the OS by a filter driver.

### DETAILED DESCRIPTION

Various embodiments according to the invention will be described hereinafter with reference to the accompanying drawings. In general, according to one embodiment of the invention, there is provided an information processing apparatus including a pattern acquiring unit to acquire an access pattern of a series of read access to a storage device when an operating system is booted, a data pre-read unit to pre-read read access target data from the storage device based on the access pattern and to load the data in a memory when the operating system is booted next, and an access unit to supply data requested by the read access to the operating system when the requested data exists in data loaded in the memory. These and other “units” forming embodiments of the invention may be hardware and/or software.

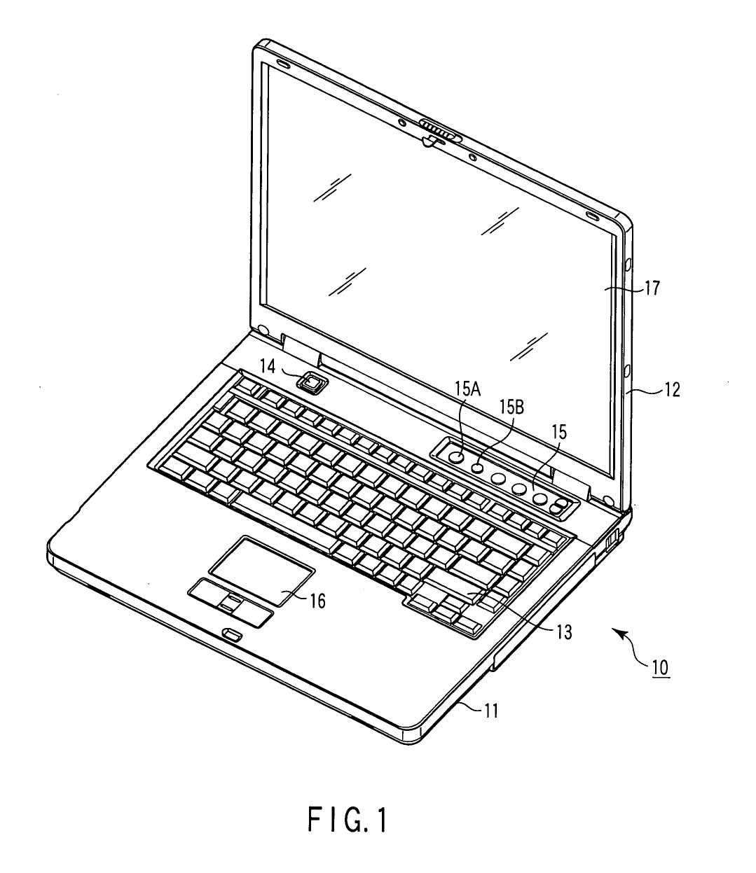

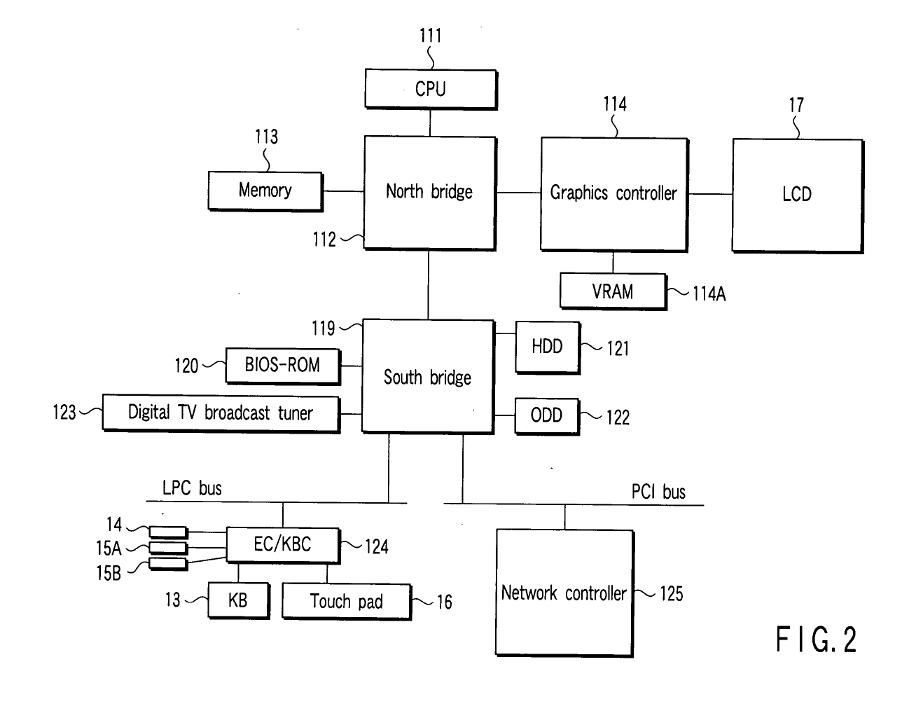

The configuration of an information processing apparatus according to one embodiment of the present invention will be explained below with reference to FIG. 1 and FIG. 2. The information processing apparatus is realized as a notebook personal computer 10, for example.

FIG. 1 is a front view showing a state that a display unit of a notebook personal computer 10 according to one embodiment of the present invention is opened. The computer 10 is composed of a computer body 11 and a display unit 12. The display unit 12 has a built-in display device comprising a liquid crystal display (LCD) 17. A display screen of the LCD 17 is positioned at the center of the display unit 12.

The display unit 12 is attached to the computer body 10 to be rotatable between an opening position and a closed position. The computer body 11 has a thin box-shaped case. The upper surface of the computer body 11 is provided with a keyboard 13, a power button 14 for turning power the computer 10 on/off, an input control panel 15 and a touch pad 16.

The control panel 15 is an input device for commencing an event in response to depression of one or more buttons, and includes several buttons for booting several functions. These buttons include a TV boot button 15A, and a digital versatile disc (DVD) boot button 15B. The TV boot button 15A is a button for booting a TV function of reproducing and recording broadcast program data such as digital TV broadcast program. When the user presses the TV boot button 15A, an application program for executing the TV function is automatically booted. The DVD boot button 15B is a button for reproducing video contents recorded in a DVD. When the user presses the DVD boot button 15B, an application program for reproducing video contents is automatically booted.

The system configuration of the computer 10 will be explained below with reference to FIG. 2.

As shown in FIG. 2, the computer 10 includes CPU 111, north bridge 112, main memory 113, graphics controller 114, south bridge 119, BIOS-ROM 120, hard disk drive (HDD) 121 and optical disk drive (ODD) 122. The computer 10 further includes digital TV broadcast tuner 123, embedded controller/keyboard controller (EC/KBC) 124 and network controller 125.

The CPU 111 is a processor provided for controlling the operation of the computer 10. According to one embodiment of the invention, CPU 111 executes an operating system (OS), file system, and various drivers and applications, all of which may be loaded from the hard disk drive 121 to the main memory 113.

Moreover, the CPU 111 executes system basic input output system (BIOS) stored in the BIOS-ROM 120. This system BIOS is a program for controlling hardware.

The north bridge 112 is a bridge device, which makes a connection between a local bus of the CPU 111 and the south bridge 119. According to one embodiment of the invention, the north bridge 112 has a built-in memory controller for controlling an access of the main memory 113. Moreover, the north bridge 112 has a function of making communications with the graphics controller 114 via an accelerated graphics port (AGP) bus.

The graphics controller 114 is a display controller, which controls the LCD 17 used as a display monitor of the computer 10. The graphics controller 114 generates a display signal to be sent to the LCD from image data written in a video memory (VRAM) 114A.

The south bridge 119 controls various devices connected via a low pin count (LPC) bus and peripheral component interconnect (PCI) bus. Moreover, the south bridge 119 has a built-in integrated drive electronics (IDE) controller for controlling HDD 121 and ODD 122. The south bridge 119 further has a function of controlling the digital TV broadcast tuner 123 and a function of controlling an access to the BIOS-ROM 120.

The HDD 121 is a storage device storing various software and data. The optical disk drive (ODD) 123 is a drive unit for driving a storage medium such as DVD stored with video content. The digital TV broadcast tuner 123 is a receiver for receiving broadcast program data such as digital TV broadcast programs externally.

According to one embodiment of the invention, the EC/KBC 124 is a one-chip microcomputer, which integrated with controllers given below. One is an embedded controller for power management, and another is a keyboard controller for controlling a keyboard (KB) 13 and a touch pad 16. The EC/KBC 124 has a function of controlling the supply of power (on/off) for the computer 10 when user operates the power button 14. The EC/KBC 124 further controls the supply of power for the computer 10 when user operates TV and DVD boot buttons 15A and 15B. The network controller 125 is a communication device for making communications with external network such as Internet.

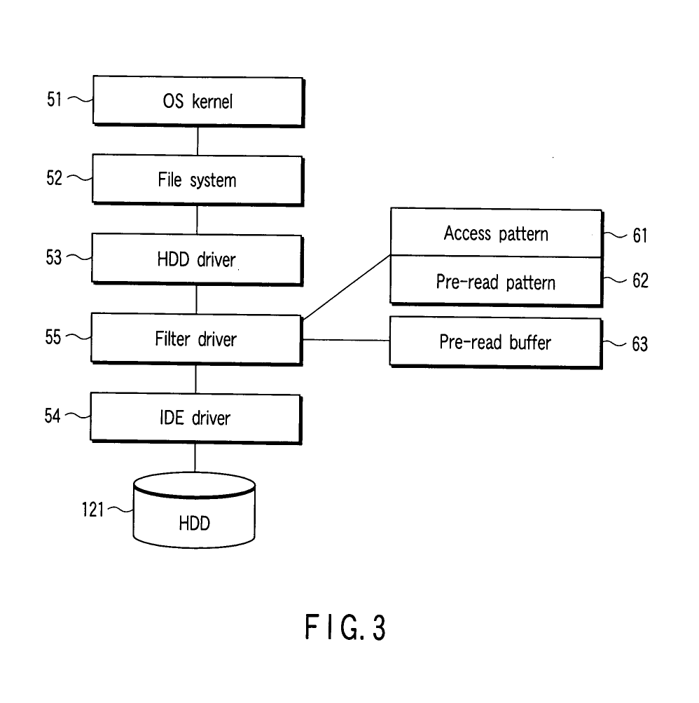

FIG. 3 is a block diagram showing the configuration of various software intervening in a read access to the HDD 121 when an OS included in the computer 10 is booted.

According to this embodiment, the computer 10 is provided OS kernel 51, file system 52, HDD driver 53, IDE driver 54 and filter driver 55 as software intervening in a read access to the HDD 121.

The OS kernel 51 is a program for executing OS basic functions. The file system 52 is a program for managing various data in a file format. The HDD driver 53 is a program for controlling the HDD 121. The IDE driver 54 is a program for controlling the HDD 121 via an IDE interface.

The filter driver 55 is a program logically operating between the HDD driver 53 and the IDE driver 54. The filter driver 55 has the following functions or may be formed with the following units. One is a pattern acquiring function (unit) of acquiring an access pattern 61 of a series of read access to the HDD 121 when the OS is booted. Another function (unit) is a data pre-read function, namely of pre-reading read access target data in the next OS boot based on the access pattern 61 from the HDD 121, and loading the pre-read data to a pre-read buffer 63. Another is an access function (unit) of supplying data requested by a read access from the OS kernel 51 if the requested data exists in data stored in the pre-read buffer 63. The foregoing pattern acquiring function (unit) may be provided with the following function. Specifically, there is provided a function of (unit for) creating a pre-read pattern 62 showing the data and sequence to be pre-read via the data pre-read function based on the acquired access pattern.

According to the foregoing pre-read, when data shown by the acquired access pattern includes a group of continuous data with continuous physical addresses, the group of continuous data is read out in a lump.

Moreover, according to the foregoing pre-read, data commonly shown by individual access patterns acquired in the past may be pre-read as a pre-read target. Moreover, if a count of read accesses reaches a count of read accesses in the past boot, the pre-read buffer 63 is released from the memory 113.

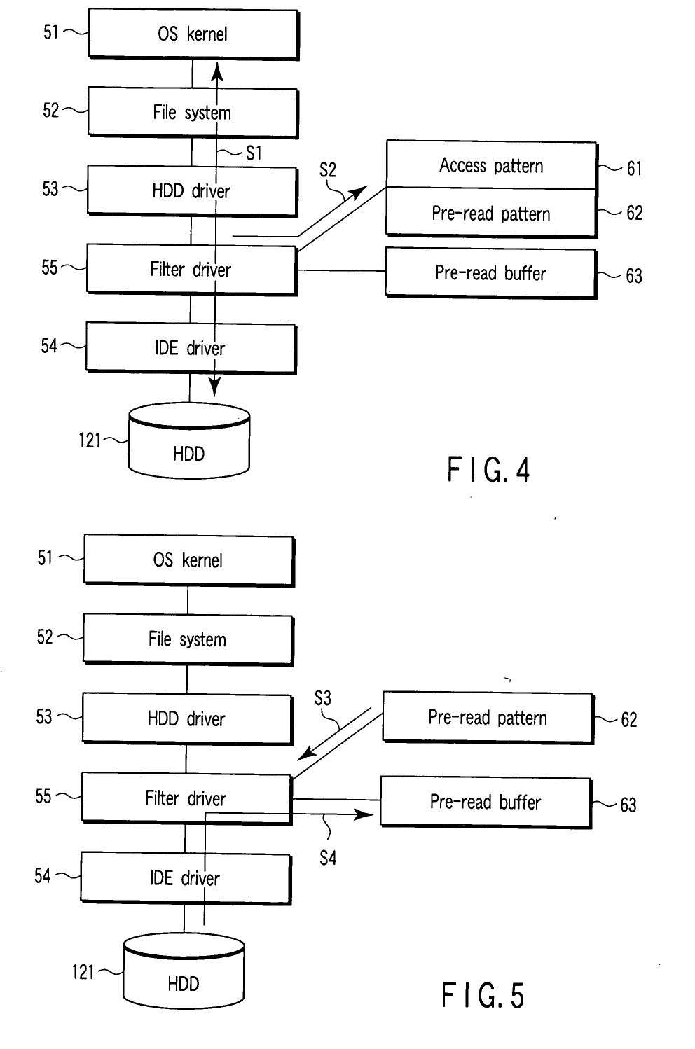

The procedure realized by various functions of the filter driver 55 will be explained below with reference to FIG. 4 to FIG. 6.

<Acquisition of Access Pattern>

FIG. 4 is a view to explain a procedure realized by the pattern acquiring function of the filter driver 55.

The filter driver 55 acquires the content of individual read accesses to the HDD 121 when the OS is booted via file system 52 and HDD driver 53 (block S1). Then, the filter driver 55 stores the content in a predetermined storage area (on memory 113 of FIG. 2) as an access pattern (block S2). The access pattern includes the following information.

Data start address (logical block address (LBA))

Data size (number of blocks)

Count of access

Access sequence

Incidentally, the filter driver 55 saves acquired access pattern after the OS has been booted in a predetermined file together with access pattern acquired in the past. After the OS is fully booted, the filter driver 55 calculates data and sequence to be pre-read when the OS is booted next. Then, the filter driver 55 combines the calculated result with the foregoing access pattern as a pre-read pattern, and thereafter, saves it. The file thus created is stored in the HDD 121.

<Creation of Pre-Read Pattern>

A pre-read pattern is determined to read data having continuous physical address in a lump while keeping access sequence of data to be pre-read.

For example, if read is normally carried out in sequence of data 1, data 2, data 3, data 4 and data 5 as shown in FIG. 7A, data 1 and data 5 are continuous while data 3 and data 4 are continuous. In this case, data 1 and data 5 are read in a lump, and data 3 and data 4 are read in a lump, as seen from FIG. 7B.

In other words, a procedure of reading data having data size “Size” starting from logical block address “Address” is expressed as Read (Address, size). By doing so, read is achieved via three times, that is, Read (n1, s1+s5), Read (n2, s2) and Read (n3, s3+s4). On the other hand, in the conventional case, read has been carried out via five times, that is, Read (n1, s1), Read (n2, s2), Read (n3, s3), Read (n4, s4), and Read (n5, s5).

<Pre-Reading>

FIG. 5 is a view to explain a procedure realized by the data pre-read function of the filter driver 55.

The filter driver 55 is loaded as one of the drivers required when the OS is booted. When being booted, the filter driver 55 secures the pre-read buffer 63, and then, starts pre-read (block S4) according to the pre-read pattern 62 previously created based on the pre-read pattern 61 (block S3).

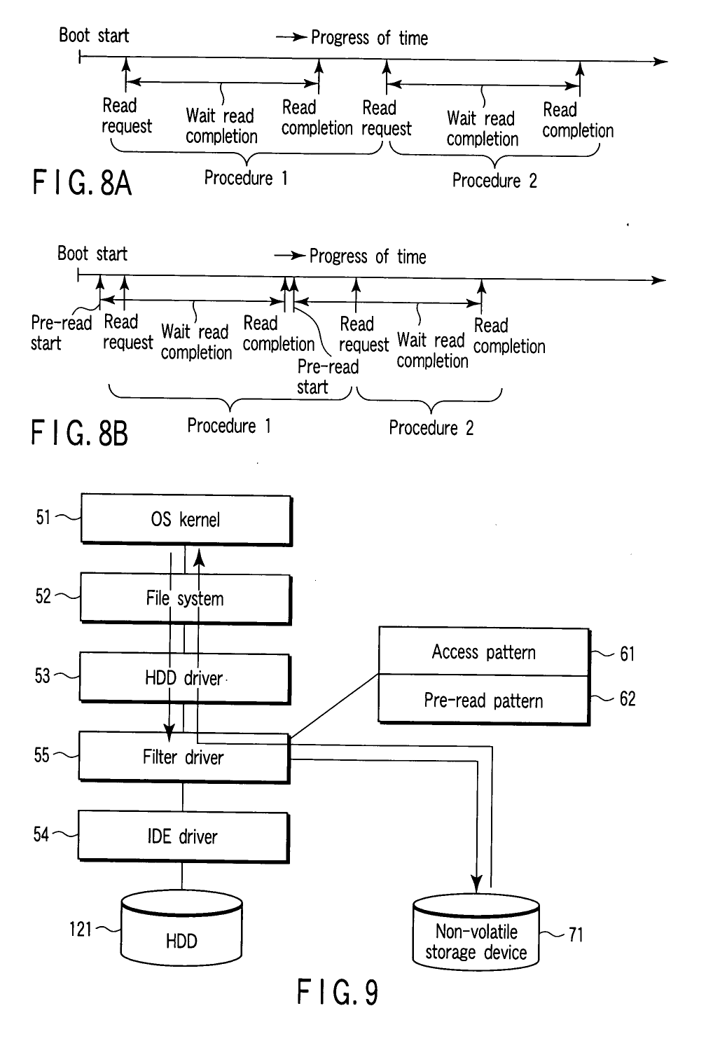

Conventionally, no pre-read has been carried out in a series of procedures (procedure 1, procedure 2, . . . ) when the OS is booted as depicted in FIG. 8A. For this reason, time is taken as a whole. In this embodiment, conversely, pre-read is started before a read request is made in each procedure as seen from FIG. 8B. Therefore, processing time is shortened as a whole.

The pre-read buffer 63 is secured at a unit of access when the OS is booted in the past. This is because the pre-read buffer 63 is needed to be released from the memory 113 of FIG. 2 if access reaches a necessary count. If continuous access data is secured in a lump without securing the pre-read buffer 63 at a unit of access, all areas are not released until access reaches a predetermined count. Therefore, if there is a need of reading data required by several accesses in a lump, another read buffer is secured, and then, data is temporarily read to the read buffer. Thereafter, the data is transferred to a pre-read buffer secured at a unit of access.

<Procedure to Read Request from OS>

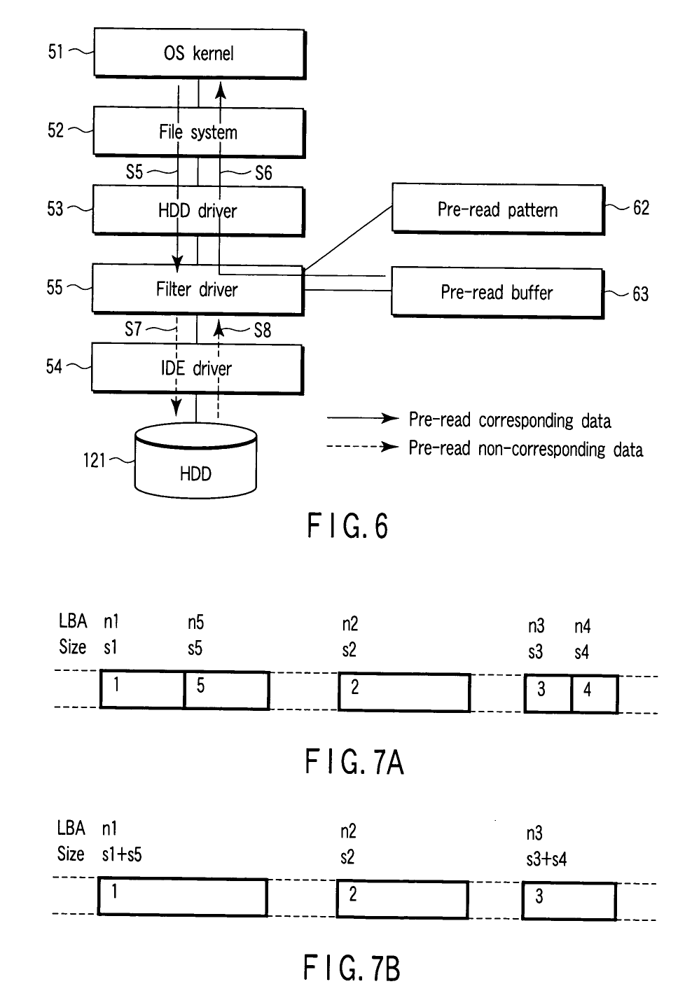

FIG. 6 is a view to explain a procedure realized by the access function of the filter driver 55.

When a read request to data included in the pre-read pattern 62 is made (block S5), the filter driver 55 returns data included in the pre-read buffer 63 to the OS kernel 51 if the corresponding data is read in the pre-read buffer 63 (block S6). If read is not completed, the filter driver 55 returns read data after waiting read completion, and then, completes read request. On the other hand, when a read request to data, which is not included in the pre-read pattern 62 is made, the filter driver 55 entrust the procedure to normal HDD access sequence, and then, returns data read from the HDD 121 to the OS kernel 51 (blocks S7, S8).

<Release of Pre-Read Buffer>

The filter driver 55 releases the pre-read buffer 63 from the memory 113 of FIG. 2 when a count of actual accesses reaches a count of accesses when the OS is booted in the past.

The pre-read buffer 63 is used to store pre-read data in the foregoing embodiment. Alternatively, the computer may be provided with a high-speed non-volatile storage device 71 (flash memory, etc.) as shown in FIG. 9. In this case, pre-read data may be held in the storage device 71 to carry out read from the storage device 71 when the OS is booted, in place of pre-read using the pre-read buffer 63.

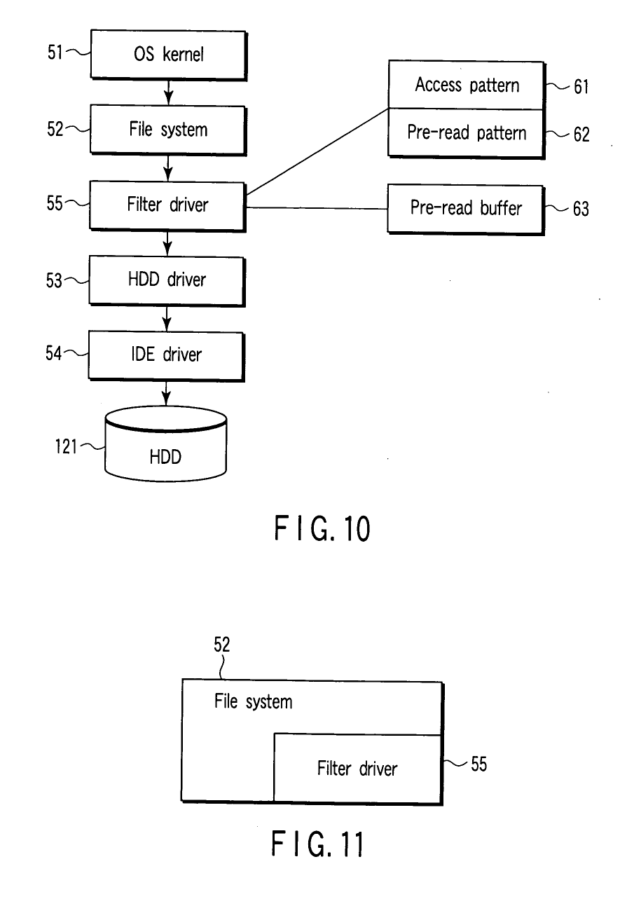

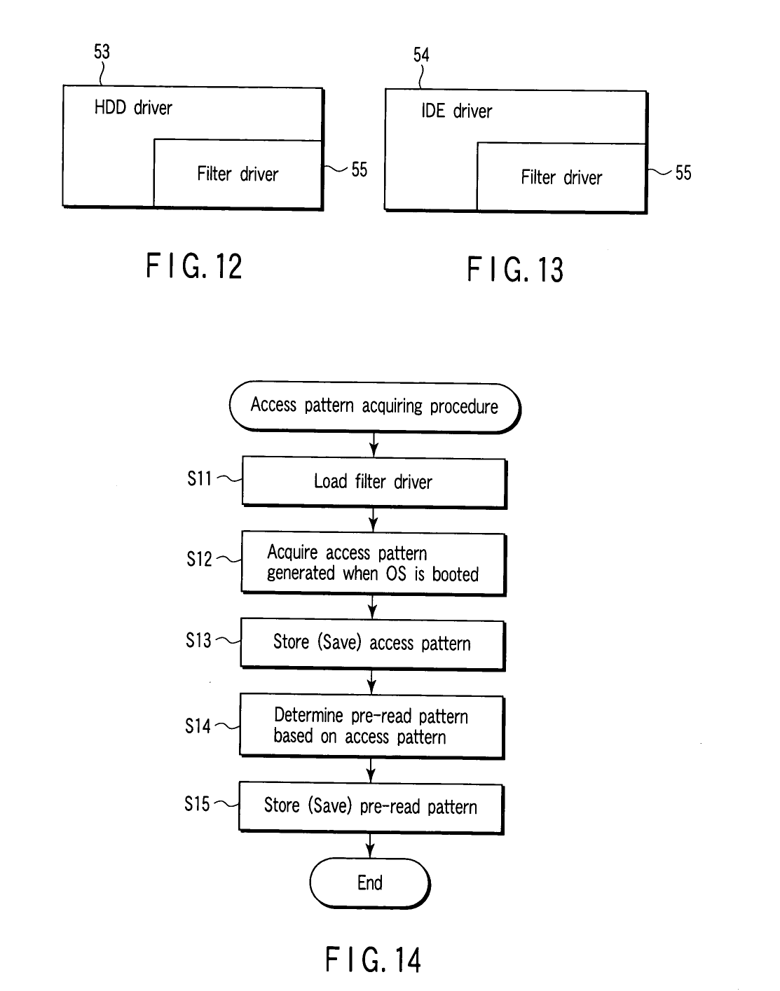

In the foregoing embodiment, the filter driver 55 logically operates between the HDD driver 53 and the IDE driver 54. However, the invention is not limited to the foregoing configuration. For example, the filter driver 55 may be located between the file system 52 and the HDD driver 53 as shown in FIG. 10. Moreover, the feature of the filter driver 55 may be included in the file system driver as shown in FIG. 11 or the HDD driver 53 as shown in FIG. 12 or the IDE driver 54 as shown in FIG. 13.

<Procedural Operations>

An access pattern acquiring procedure by the filter driver 55 will be explained below with reference to a flowchart of FIG. 14.

When the OS is booted, the filter driver 55 is loaded in the memory 113 in addition to HDD driver 53 and IDE driver 54 (block S11). Then, the filter driver 55 acquires an access pattern generated from the OS kernel 51 (block S12). After the OS boot is completed, the filter driver 55 stores (saves) the access pattern in the HDD 121 (block S13). The filter driver 55 determines data and sequence to be pre-read when the OS is booted next (block S14). Thereafter, the filter driver 55 combines the result with the foregoing access pattern, and stores (saves) it as a pre-read pattern (block S15).

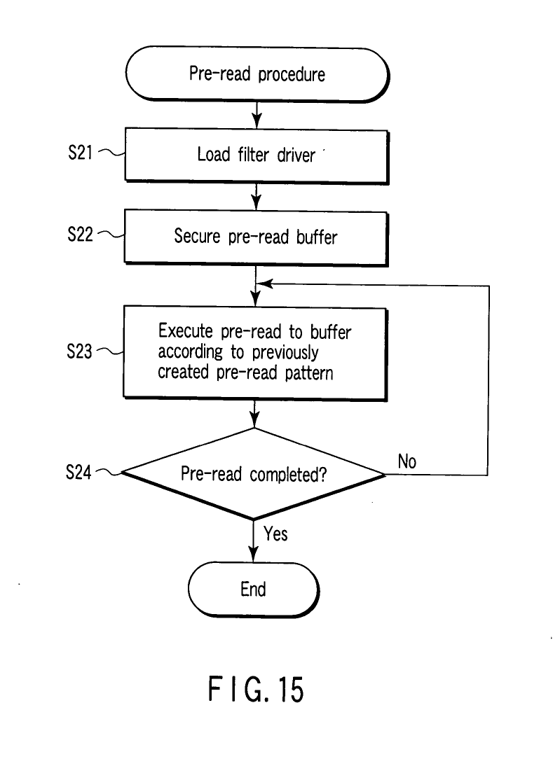

A pre-read procedure by the filter driver 55 will be explained below with reference to a flowchart of FIG. 15.

When the OS is again booted after the procedure of FIG. 14 is taken, the filter driver 55 is loaded in the memory 113 in addition to HDD driver 53 and IDE driver 54 in the OS boot (block S21). Then, the filter driver 55 secures the pre-read buffer 63 (block S22), and executes pre-read according to the pre-read pattern 62 previously created based on the pre-read pattern 61 (block S23). The filter driver 55 ends the pre-read procedure if it confirms that all data read to the pre-read buffer 63 is completed (block S24).

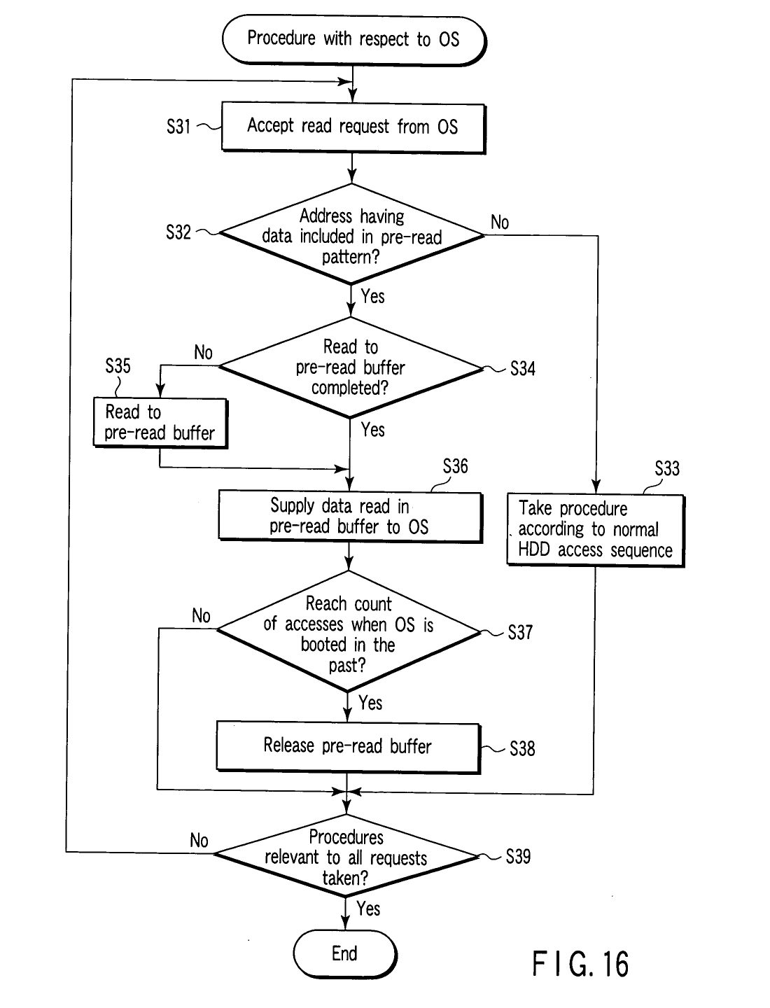

A procedure with respect to the OS by the filter driver 55 will be explained below with reference to a flowchart of FIG. 16.

The filter driver 55 booted in the procedure of FIG. 15 takes a procedure in accordance with a read request from the OS kernel 51 in addition to the foregoing pre-read procedure. Specifically, the filter driver 55 detects a read request from the OS kernel 51 via file system 52 and HDD driver 53 (block S31). When detecting the read request, the filter driver 55 determines whether or not an address range shown by the read request is included in the pre-read pattern 62 (block S32). If the address range is not included, the filter driver 55 entrusts the procedure to normal HDD access sequence (block S33). On the other hand, if the address range is included, the filter driver 55 determines whether or not data having the address range is already read in the pre-read buffer 63 (block S34). If read is not completed, the filter driver 55 executes read to the pre-read buffer directly (block S35), and thereafter, supplies the corresponding data to the OS kernel 51 (block S36). Then, the filter driver 55 determines whether or not a count of actual accesses reaches a count of accesses when the OS is booted in the past (block S37). If the count of actual accesses exceeds the readers of the past access, the filter driver 55 releases the pre-read buffer 63 from the memory 113 (block S38). Otherwise, the filter driver 55 does not still release the pre-read buffer 63. Finally, the filter driver 55 confirms that procedures relevant to all requests from the OS kernel 51 are taken (block S39), and thereafter, ends this procedure.

As described above, this embodiment adopts a driver which executes pre-reading in view of the case where the same data having the same address is frequently read every when the OS is booted. Since data in which a read request is made from the OS can be predicted based on the past (old) access pattern, it is possible to shorten the time spent for OS boot by pre-reading the data in the pre-read buffer 63.

Moreover, this embodiment adopts a driver which pre-reads physically continuous data in a lump in one-time read procedure in view of the case where a several times of readings are executed for the physically continuous data when the OS is booted. Since the continuous data is read out in a lump in one-time read procedure, it is possible to shorten the time taken to read data as a whole.

Moreover, the pre-read buffer 63 of this embodiment is not a newly provided hardware buffer, but secured on the existing memory 113 using software. Therefore, this serves to reduce an increase of cost, and a design change is easy to be made.

Moreover, this embodiment adopts a driver which successively releases the pre-read buffer when access reaches a count of accesses shown by the past access pattern in view of the case where other drivers and applications cannot use the storage area used as the buffer if the pre-read buffer 63 is continuously secured for the duration when the OS is booted. By such technique, as the boot is gradually progressing and the driver/application are started, usable storage area increases whereas the pre-read buffer is successively released, so that free space (capacity) of the memory 113 is secured.

As described above, according to the above-described embodiment, high-speed read access is effectively realized.

Various procedures of the present invention described in the foregoing embodiment are stored in a computer readable storage medium (e.g., magnetic disk, optical disk, semiconductor memory) as a computer program. The foregoing computer program may be read and executed using a processor as a need arises. The computer program is transmitted from one computer to another computer via communication medium, and thereby, the computer program may be delivered.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a pattern acquiring unit to acquire an access pattern of a series of read accesses to a storage device when an operating system is booted;
a data pre-read unit to pre-read read access target data from the storage device based on the access pattern and to load the read access target data in a memory when the operating system is booted next; and
an access unit to supply data requested by a read access to the operating system when the requested data exists in data loaded in the memory.

2. The apparatus according to claim 1, further comprising:
a pre-read pattern creating unit to create a pre-read pattern showing data and sequence to be pre-read by the data pre-read unit based on the acquired access pattern.

3. The apparatus according to claim 1, wherein when data shown by the acquired access pattern includes a group of continuous data with continuous physical addresses, the data pre-read unit reads the group of continuous data in a lump.

4. The apparatus according to claim 1, wherein the data pre-read unit pre-reads data commonly shown by individual access patterns acquired in the past as a pre-read target.

5. The apparatus according to claim 1, wherein the data pre-read unit secures a buffer for holding data pre-read from the storage device in the memory.

6. The apparatus according to claim 5, wherein the access unit releases the buffer from the memory when a count of read accesses reaches a count of read accesses in a past boot.

7. The apparatus according to claim 1, wherein the pattern acquiring unit, the data pre-read unit and the access unit are realized as a driver logically operating between a file system driver and a hard disk drive (HDD) driver or between a hard disk drive (HDD) driver and an integrated drive electronics (IDE) driver.

8. The apparatus according to claim 1, wherein the pattern acquiring unit, the data pre-read unit and the access unit are realized as a driver, is the driver being built in any one of a file system driver, a hard disk drive (HDD) driver and an integrated drive electronics (IDE) driver.

9. A method comprising:
acquiring an access pattern of a series of read accesses to a storage device when an operating system is booted;
pre-reading read access target data from the storage device based on the access pattern and loading the data in a memory when the operating system is booted next; and
supplying data requested by a read access to the operating system when the requested data exists in data loaded in the memory

10. The method according to claim 9, further comprising:
creating a pre-read pattern showing data and sequence to be pre-read by the data pre-read unit based on the acquired access pattern.

11. The method according to claim 9, wherein when data shown by the acquired access pattern includes a group of continuous data with continuous physical addresses, the group of continuous data is read out in a lump.

12. The method according to claim 9, wherein the pre-reading includes pre-reading data commonly shown by individual access patterns previously acquired as a pre-read target.

13. The method according to claim 9, further comprising:
securing a buffer for holding data pre-read from the storage device in the memory.

14. The method according to claim 9, further comprising:
releasing the buffer from the memory when a count of read accesses reaches a count of read accesses in a past boot.

15. A storage medium storing computer-executable program code executed by a processor for performing read access control in a computer, the program code comprising:
code to acquire an access pattern of a series of read accesses to a storage device when an operating system is booted;
code to pre-read read access target data from the storage device based on the access pattern and loading the data in a memory when the operating system is booted next; and
code to supply data requested by the read access to the operating system when the requested data exists in data loaded in the memory.

16. The storage medium according to claim 15, wherein the program code further comprising:
code to create a pre-read pattern showing data and sequence to be pre-read based on the acquired access pattern.

17. The storage medium according to claim 16, wherein the program code further comprises code to collectively read a group of continuous data with continuous physical addresses.
